(19) United States
(12) Patent Application Publication
(10) Pub. No.: US 2025/0225834 A1
(43) Pub. Date: Jul. 10, 2025

(54) AUTONOMOUS BEVERAGE DISPENSING SYSTEM

(71) Applicant: COSTA EXPRESS LIMITED, Buckinghamshire (GB)

(72) Inventors: Andrew William MOORE, Austin, TX (US); Jordan Jeffery HAWKES, Austin, TX (US); Angelo FANCELLO, Austin, TX (US)

(21) Appl. No.: 18/853,346

(22) PCT Filed: Mar. 31, 2023
(86) PCT No.: PCT/EP2023/058466

§ 371 Date: Oct. 1, 2024

Related U.S. Application Data
(60) Provisional application No. 63/362,359, filed on Apr. 1, 2022.

(51) Int. Cl. G07F 13/10; B25J 11/00

(52) U.S. Cl. CPC G07F 13/10; B25J 11/0045

(57) ABSTRACT

Provided is an autonomous retail kiosk for serving beverages a method of operating said autonomous retail kiosk, wherein the autonomous retail kiosk comprises two or more production workcells and a carousel and, wherein each production workcell comprises a robotic arm for moving beverages between the beverage dispenser, the presentation station and the carousel.

### BACKGROUND

Known autonomous retail systems for serving beverages fall into a number of distinct categories. Firstly, there are “vending machine” type retail systems which dispense bottled, canned, or otherwise packaged beverages to a user. Secondly, there are “self-serve” retail systems in which a user manually places a beverage container underneath a beverage dispenser, which dispenses a beverage into the container, the user then removes the container, applying a lid and any further condiments as necessary. An example of a “self-serve” retail system is described in PCT Pub. No. WO2014/075833 (also published as U.S. Patent Pub. No. 2015/0245734A1). A problem with the vending-machine type of retail system is that typically only cold beverages can be dispensed. The self-serve retail systems are generally capable of producing hot and cold beverages, such as coffee and iced coffee. However, as discussed above self-serve retail systems require the user to manually place a beverage container beneath the beverage dispenser and apply a lid as necessary. This results in resources such as beverage containers and lids being freely accessible to the user. Consequently, this raises issues surrounding the level of hygiene and the potential for tampering with said resources. Furthermore, self-serve retail systems can typically only be positioned in areas where an attendant can continuously monitor and replenish resources, including the beverage containers and lid previously mentioned, due to limited storage capabilities of such machines. Furthermore, self-serve retail systems are typically positioned in areas where an attendant is available to support a user on the “unhappy journeys” where issues emerge, especially those that emerge after payment. Therefore, there is a need for more reliable systems that can be positioned in areas where no attendant is available.

In an attempt to solve the problems associated with existing self-serve retail systems, there have been a number of developments in autonomous retail kiosks for serving beverages which attempt to replicate the function of a human serving in a café or coffee shop by serving the consumer a finished beverage in a lidded beverage container. However, existing autonomous retail kiosks are very complex, and have limited redundancy in resources to cope with a failure in any one resource. If any one resource, such as a beverage dispenser, fails, then the autonomous kiosk will be out of service and unable to serve beverages. There is a need for an improved autonomous retail kiosk for serving beverages that addresses these issues.

### SUMMARY

An autonomous retail kiosk for serving beverages is provided according to a first aspect, comprising two or more production workcells and a carousel, wherein;

each production workcell comprises; a beverage dispenser for dispensing liquid, a presentation station for presenting a beverage to the consumer, a robotic arm for moving beverages between the beverage dispenser, the presentation station and the carousel; and wherein said carousel is configured to receive a beverage container from a first robotic arm within a first workcell and deliver the beverage container to a second robotic arm within a second workcell, thereby moving the beverage container from the first workcell to the second workcell.

Optionally, the planes in which each robotic arm is configured to move in consist of the lateral, vertical and transverse planes. The robotic arms may be configured to move according to spherical coordinates in the r, z and psi directions.

Optionally, the autonomous retail kiosk further comprises one or more beverage makers configured to provide a beverage to the beverage dispenser. Optionally, the beverage dispenser is a moveable beverage dispensing head that is tiltable and elevatable. Optionally, the presentation station comprises a rotating platform. Optionally, the autonomous retail kiosk further comprises one or more direct beverage contributors configured to provide an ingredient or process to a cup (e.g. ice, blender head, muffin, portion of ice cream).

Optionally, the kiosk comprises two substantially identical production workcells with bilateral symmetry.

Optionally, each robotic arm is configured to: move a beverage container from a beverage container dispenser to a beverage dispenser, move the beverage container from the beverage dispenser to the carousel, and move the beverage container from the carousel to a presentation station.

Optionally, the autonomous retail kiosk further comprises a beverage container lidding station comprising a beverage container lidder which serves the two or more production workcells, or wherein each of the two or more production workcells further comprises one or more beverage container lidding stations each comprising a beverage container lidder.

Optionally, the autonomous retail kiosk further comprises a beverage disposal receptacle for receiving a waste beverage from a robotic arm or from another actuator.

Optionally, the carousel is further configured to receive a beverage container from a robotic arm and deliver the beverage container to the same robotic arm, thereby acting to store the beverage container.

In a second aspect, a method of operating an autonomous retail kiosk comprising two or more production workcells and a carousel is provided, comprising the steps of, in a first production workcell dispensing a beverage container from a beverage container dispenser to a first robotic arm, and using the first robotic arm, moving the beverage container to the carousel, and the method further comprises: removing the beverage container from the carousel using one of the first robotic arm or a second robotic arm in a second production workcell.

Optionally, the method further comprises moving the beverage container from the beverage container dispenser to a first beverage dispenser using the first robotic arm, dispensing a liquid from the beverage dispenser into the beverage container.

Optionally, the method further comprises presenting the beverage container to the consumer by placing the beverage container on a presentation station using the one of the first robotic arm or the second robotic arm.

Optionally, removing the beverage container from the carousel uses the second robotic arm in the second production workcell, and the method further comprises; dispensing a liquid from the beverage dispenser in the second production workcell into the beverage container, and presenting the beverage container to the consumer by placing the beverage on a presentation station using the second robotic arm.

Optionally, removing the beverage container from the carousel uses the second robotic arm in the second production workcell, and the method further comprises; dispensing a liquid from the beverage dispenser in the second production workcell into the beverage container, moving the beverage container to the carousel using the second robotic arm and the method further comprises removing the beverage container from the carousel using one of the first robotic arm or a second robotic arm in a second production workcell, and presenting the beverage container to the consumer by placing the beverage on a presentation station using the one of the first robotic arm or the second robotic arm.

Optionally, the method further comprises the steps of receiving at a controller information relating to ingredient or hardware resource availability of the two or more production workcells, determining based on said information if one or more of the two or more production workcells are capable of producing a beverage alone or in combination, and based on said determination performing the method described above.

### BRIEF DESCRIPTION OF THE DRAWINGS

Specific implementations of the present disclosure are described below in the detailed description by way of example only and with reference to the accompanying drawings, in which:

FIGS. 1a-1b show a simplified view of an example layout for an automated beverage system;

FIGS. 2a-2e show simplified schematics of arrangements of workcells around a carousel; and

FIG. 3 shows an example combination of a carousel for use in an automated beverage system.

FIG. 4 shows an example flowchart describing a method of operation of the system of the present disclosure.

Like reference numerals are used for like components throughout the drawings.

### DETAILED DESCRIPTION

The term “degrees of freedom” is used interchangeably herein with “number of axis” and is used to define the motion capabilities of a robotic arm. For example, a robotic arm with one degree of freedom or one axis can move along a straight line x axis. A robotic arm with two degrees of freedom or two axes can move horizontally and vertically in one x/z plane. A robotic arm with three degrees of freedom or three axes can move horizontally, vertically, and backwards/forwards in x/y/z space. A robotic arm with four degrees of freedom can move horizontally, vertically, and backwards/forwards in x/y/z space, as well as change an object's orientation along one axis (e.g. yaw). A robotic arm with five degrees of freedom or five axes can move horizontally, vertically, and backwards/forwards in x/y/z space, as well as change an objects orientation along two axes (e.g. yaw and pitch). A robotic arm with six degrees of freedom or six axes can move horizontally, vertically, and backwards/forwards in x/y/z space, as well as change an object's orientation along three axes (e.g yaw, pitch and roll).

The term “resource” as used herein refers to both hardware resources such as robotic arms, beverage dispensers, presentation stations, beverage makers, beverage container dispensers, beverage disposal modules, ice dispensers, beverage container lidders, and carousel(s), as well as consumable resources such as coffee beans, milk, beverage containers, beverage container lids, water, flavour syrups, and ice.

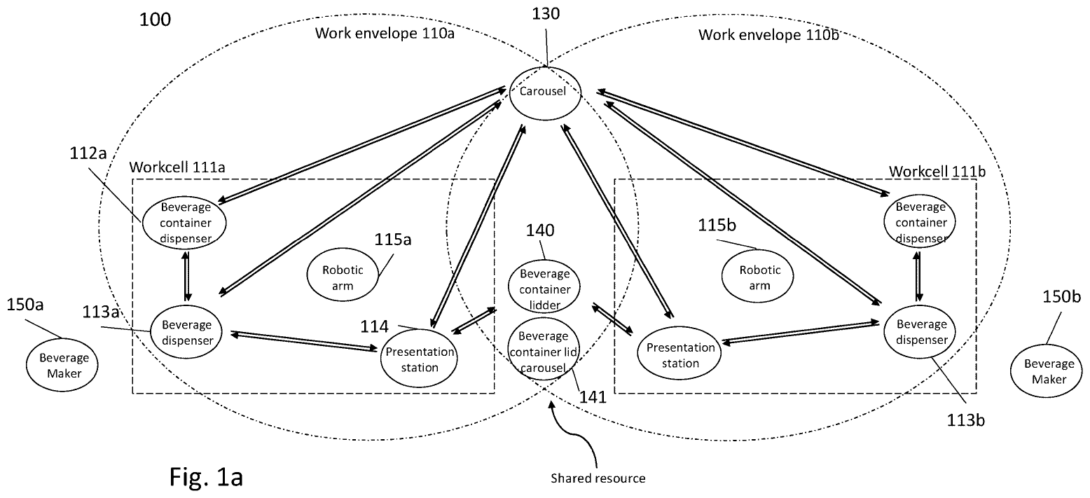

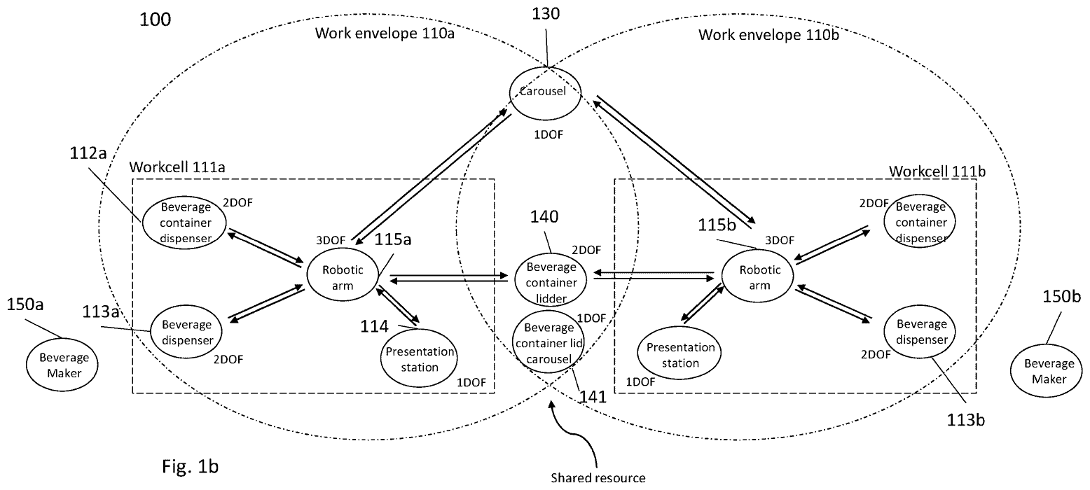

FIG. 1a shows an example layout of an autonomous retail kiosk 100, according to the present disclosure. Autonomous retail kiosk 100 can be an automated beverage system. The autonomous retail kiosk 100 of FIG. 1 comprises two overlapping work envelopes, 110, 120. The area in which a robotic arm is able to operate is sometimes referred to as a work envelope. The term “production workcell” as used herein refers to a group of hardware resources that are located within the work envelope of a single robotic arm. Preferably, each production workcell comprises a beverage dispenser 113a, 113b for dispensing liquid, a presentation station 114 for presenting a beverage to the consumer, and a robotic arm 115a, 115b for moving beverages between the beverage dispenser 113a, 113b, the presentation station 114 and a carousel 130. is the automated beverage system may comprise an ice dispenser (not shown in FIG. 1). The consumer can be a human or machine operator or user of autonomous retail kiosk 100.

Each production workcell may further comprise a beverage maker 150, or a beverage maker 150 may be shared between workcells. The first production workcell 111a comprises a beverage container dispenser 112a, a beverage dispenser 113a and a presentation station 114a. The robotic arm 115a of the first production workcell 111a is operable to access each of the beverage container dispenser 112a, the beverage dispenser 113a and the presentation station 114a. The robotic arm 115a is also arranged to access the carousel 130. The arrows in FIG. 1a demonstrate the flow of the beverage container around the workcell and between workcells via the carousel 130.

FIG. 1b shows an example layout of an autonomous retail kiosk 100, according to the present disclosure. Preferably, each production workcell comprises a beverage dispenser 113a, 113b for dispensing liquid, a presentation station 114 for presenting a beverage to the consumer, and a robotic arm 115a, 115b for moving beverages between the beverage dispenser 113a, 113b, the presentation station 114 and a carousel 130. Not shown in FIG. 1b is an ice dispenser.

In the embodiment shown in FIG. 1b, the robotic arm 115 exhibits 3 degrees of freedom and can move in the xy, yz and xz planes, the presentation station 114 has 1 degree of freedom and comprises a rotatable platform, the beverage dispenser 113 exhibits 2 degrees of freedom and can move up and down, as well as tilt, the beverage container dispenser 112 exhibits 1 degree of freedom and is rotatable, the beverage container lidder 140 exhibits 2 degrees of freedom and can move up and down as well as rotate, the beverage container lid carousel 141 exhibits one degree of freedom and can rotate, and the carousel 130 exhibits 1 degree of freedom and can rotate. The arrows in FIG. 1b demonstrate the robotic arm and its range of motion.

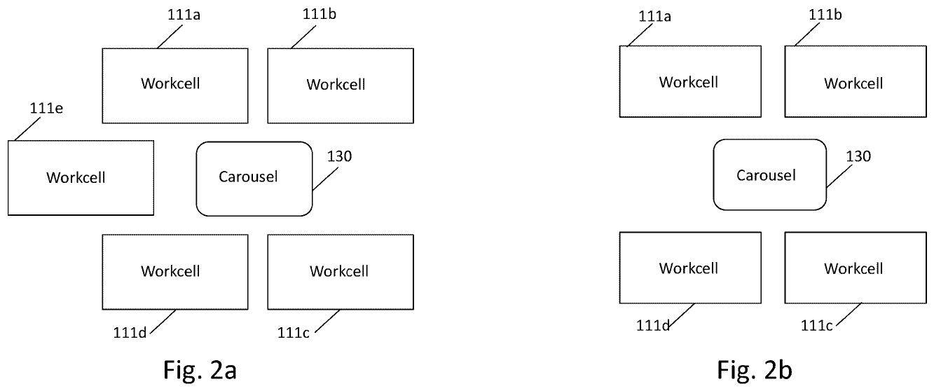

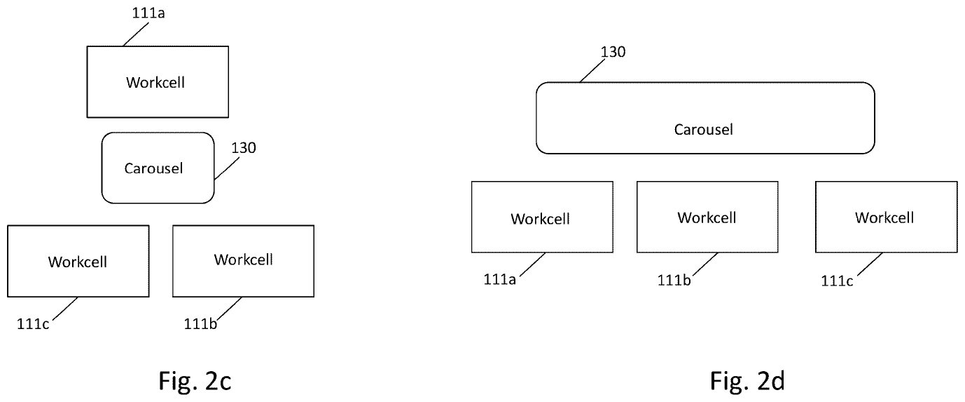

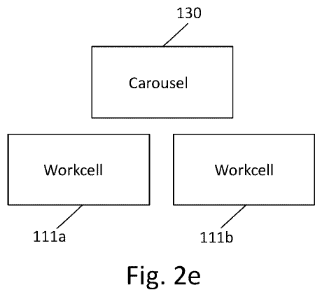

There may be any number of workcells 111 present in an autonomous retail kiosk 100, which are arranged around a common central carousel 130, as shown in FIGS. 2a-2e. For example, there may be five workcells arranged around a common central carousel 130. In the configuration where there are five workcells arranged around a common central carousel 130, two of the workcells may be positioned side to side, with a further two workcells positioned back to back with the first two workcells to form a rectangle with the carousel 130 in the centre, a further workcell may then be positioned on either end of said rectangle.

There may be four workcells arranged around a common central carousel 130. In the configuration where there are four workcells arranged around a common central carousel 130, two of the workcells may be positioned side to side, with a further two workcells positioned back to back with the first two workcells to form a rectangle with the carousel 130 in the centre. Alternatively, there may be three workcells arranged around a common central carousel 130. In the configuration where there are three workcells arranged around a common central carousel 130, two of the workcells may be positioned side to side, with a further workcell positioned back to back with the first two workcells to form a triangle with the carousel 130 in the centre. Alternatively, the three workcells may be positioned in a row.

Preferably, there are two workcells arranged around a common central carousel 130. The two workcells preferably exhibit bilateral symmetry.

### Robotic Arm

The following refers to the robotic arm 115 and a workcell 110 in general terms, and it will be appreciated that robotic arm 115b and workcell 111b (or any further workcell 111) may be arranged to operate in substantially the same manner. Each workcell 111 comprises a robot arm 115 for moving beverage containers. Preferably, the robot arm 115 comprises a number of actuators which are configured to move the robot arm 115. The robot arm 115 may exhibit any number of degrees of freedom. The robot arm 115 may exhibit 7, 6, 5, 4, 3, 2, or 1 degrees of freedom. Preferably, the robot arm 115 exhibits three degrees of freedom. Three degrees of freedom are sufficient to move an object along any or all of x, y, z axes. Preferably, the robot arm 115 is configured to move in the lateral, vertical and transverse planes (xy, yz, and xz). In other words, the robot arm 115 is preferably configured to move up and down, side to side, and forwards and backwards. A robotic arm configured in this manner may be considered an r, z, psi spherical coordinate system. In other words, the robotic arm preferably comprises a rotational hub (sweep out an arc in the psi direction), which can elevate (move up and down the z direction) and change the length of the protruding robotic arm (move along a radial, r, direction). Robotic arms which exhibit lower degrees of freedom are less expensive, simpler, and more reliable than robotic arms which exhibit higher degrees of freedom.

The robot arm 115 may be operated by any number of actuators. The robot arm 115 may in theory be operated by any form of actuator. Preferably, the robot arm 115 is operated by an electronic actuator, such as an electronic motor.

The robot arm 115 may comprise a movable gripper for holding a beverage container or a fixed gripper for holding a beverage container. Preferably, the robotic arm 115 comprises a fixed gripper for holding a beverage container. Preferably, the fixed gripper for holding a beverage container is C-shaped, or alternatively U-shaped. Since beverage containers are typically frustoconical in shape, the C-shaped hand is able to effectively grip and lift a beverage container when moved in the vertical plane relative to the beverage container since the diameter of the C-shaped gripper is between the minimum and maximum diameter of the beverage container. The robotic arm 115 may be configured to receive a beverage container from the beverage container dispenser 112, as described further below. The fixed gripper on the robotic arm 115 preferably comprises a high friction surface to effectively grip the container.

The robotic arm 115 is preferably located at or near the centre of the workcell 111, such that the various hardware resources are within the work envelope of said robotic arm 115. Positioning the robotic arm 115 in the centre of the workcell 111 means that a less complex robotic arm 115, with fewer degrees of freedom, is required to access each hardware resource. Positioning the robotic arm 115 in the centre of the workcell 111 may also enable the use of a simpler robotic arm 115 which does not need to rotate a full 360 degrees, or rotate continuously.

The robotic arm 115 is therefore preferably configured to move a beverage container between hardware resources contained within a workcell 111 or hardware resources shared between multiple workcells 111. For example, the robotic arm 115 may be configured to move a beverage container from a beverage container dispenser to a beverage dispenser 113, or from a beverage container dispenser to a carousel 130. The robotic arm 115 may be configured to move a beverage container from a carousel 130 to a beverage dispenser 113, or from a beverage container from a beverage dispenser 113 to a carousel 130. The robotic arm 115 may be configured to move a beverage container from a beverage container dispenser to an ice dispenser, or from a beverage container from an ice dispenser to a beverage dispenser 113. The robotic arm 115 may be configured to move a beverage container from a beverage dispenser 113 to an ice dispenser. The robotic arm 115 may be configured to move a beverage container from an ice dispenser to a carousel 130, or vice versa. The robotic arm 115 may be configured to move a beverage container from an ice dispenser or from a beverage dispenser 113 to a beverage container lidder. The robotic arm 115 may be configured to move a beverage container from a beverage container lidder 140 to a presentation station 114 or to a carousel 130. The robotic arm 115 may be configured to move a beverage container from a carousel 130 to a beverage container lidder 140. The robotic arm 115 may be configured to move a beverage container from a carousel 130 to a presentation station 114. The robotic arm 115 may be configured to move a beverage container from a beverage container dispenser, or from an ice dispenser to a waste receptacle. The robotic arm 115 may be configured to move a beverage container from a carousel 130 to a beverage container disposal unit. The robotic arm 115 may be configured to move a beverage container from a beverage dispenser 113 to a beverage container disposal unit. The robotic arm 115 may be configured to move a beverage container from a beverage container lidder 140 to a beverage container disposal unit. The robotic arm 115 may be configured to move a beverage container from a presentation station 114 to a beverage container disposal unit.

### Beverage Dispenser

Each workcell 111 comprises a beverage dispenser 113 for dispensing beverages. Preferably, the beverage dispenser 113 is in the form of a movable beverage dispensing head, comprising a drink dispensing nozzle. The beverage dispensing head may be elevatable (i.e., moveable up and down). The beverage dispensing head may be tiltable, such that the angle of the beverage dispensing head and the drink dispensing nozzle can be changed to optimise the delivery of the liquid. Preferably, the beverage dispensing head is both elevatable and tiltable. In other words, preferably the beverage dispensing head exhibits two degrees of freedom and is a two-axis robot. Preferably, the angle of the beverage dispensing head is adjustable so that the angle of the beverage dispensing head with respect to a beverage container can be adjusted. Preferably, when in a dispensing position, the angle of the beverage dispensing head is between 45 and 15 degrees with respect to a beverage container into which the beverage dispensing head can dispense a beverage. More preferably, the angle of the beverage dispensing head is between 40 and 25 degrees with respect to a beverage container into which the beverage dispensing head can dispense a beverage. Most preferably, the angle of the beverage dispensing head is 38 degrees with respect to a beverage container into which the beverage dispensing head can dispense a beverage. The beverage dispenser 113 can be arranged to move between a retracted position and a drink dispensing position. The beverage dispenser 113 may be arranged to move to a retracted position to allow the robotic arm 115 a fuller range of motion when moving a beverage container into and out of a position in which the beverage is dispensed into the container. Once the beverage container has been moved into a correct position, the beverage dispenser 113 may be lowered into a dispensing position, and the dispensing head may be tilted to the required angle, which may be specified depending on the beverage to be supplied.

Alternatively, or additionally, the robotic arm may be arranged to tilt the beverage container with respect to the beverage dispensing head to achieve the optimum liquid delivery height and angle into the beverage container

### Carousel

The autonomous retail kiosk comprises a carousel 130. The carousel 130 is arranged to store beverage containers and to permit the passing of beverage containers between workcells. The carousel 130 preferably comprises a number of beverage container stands attached to a belt. The container stands may be spaced around the belt, and preferably are evenly distributed. The belt is moveable such that the beverage container stands are also moveable. A beverage container on a beverage container stand can therefore be moved around the carousel 130. The carousel 130 may be arranged such that a beverage container placed on a beverage container stand may be transported around the full range of motion of the belt (i.e., in a loop), to arrive at the same point. The carousel 130 belt is preferably at least partially located within the work envelope of the robotic arms of the autonomous retail kiosk. As such, the carousel 130 is arranged to receive beverage containers from, and deliver beverage containers to all robotic arms present in the kiosk. The carousel 130 is therefore arranged to pass beverage containers between workcells of the autonomous retail kiosk. This has the advantage that if hardware or consumable resource(s) are unavailable in one workcell 111, beverage containers may be freely passed between workcells to complete beverage orders. The work envelope robotic arm of any given workcell 111 may be arranged to access a plurality of beverage containers on the carousel 130, that are located within a range of motion of the robot arm. The carousel effectively exhibits one degree of freedom, that is, by moving the belt in either direction.

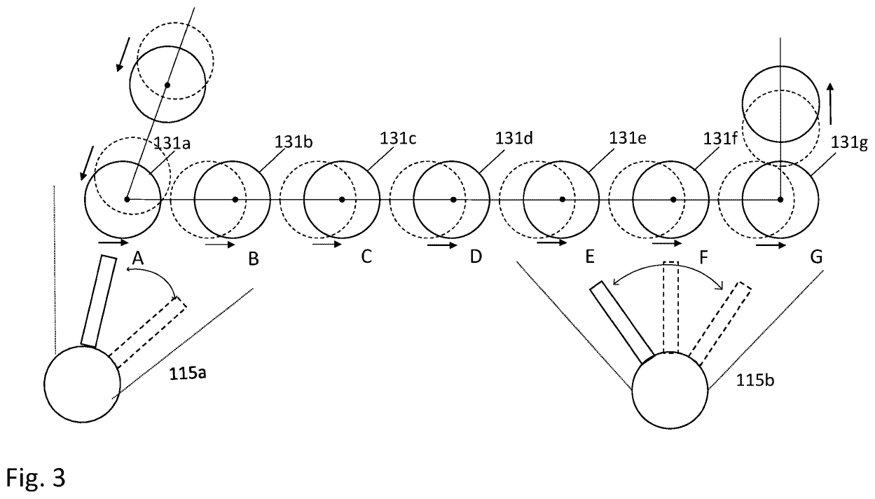

The carousel 130 may be arranged to move the beverage container stands incrementally, such that when at rest the beverage container stands are sited in consistent locations that are accessible to the robot arm. That is, the beverage container stands are moveable around the carousel 130 between a series of locations, as shown in FIG. 3. FIG. 3 shows an example carousel, comprising a plurality of beverage container stands 131a . . . 131g which are located at respective stationary load positions A, B, C . . . G. The positions A to G denote the static locations of the beverage container stands which are for receiving and delivering beverage containers. Each time the carousel moves the beverage container stands are moved to align with the stationary load positions A to G. The robot arms 115a, 115b may access more than one stationary location. As shown in FIG. 3, the robot arm 115a may access stationary locations A and B, while robot arm 115b may access stationary locations E, F, and G. It will be appreciated that the robot arms 115a and 115b in FIG. 3 can access two and three of the predetermined positions, respectively, however FIG. 3 is for illustrative purposes and a robot arm 115 may be configured to access more or fewer load positions, in reality a symmetrical system is preferable.

The robot arms 115a and 115b may deposit a beverage container in any of the stationary locations within their respective work envelope and may also retrieve a beverage container from any of the stationary locations within its work envelope. The robotic arm is required to simply rotate about one axis and extend or retract the arm in the radial direction to access the carousel stationary positions. The carousel may be operated to move beverage containers in either direction. One or more of the stationary load positions accessible by a robot arm 115 may be a preferred load position, for example load position A shown in FIG. 3, since the robot arm extension is minimised. It may be the case that in use the robot arm 115a is instructed to use load position B in case when the carousel is in heavy use, the beverage container stand in load position A already has a beverage container located there, and a concurrent action is taking place at another robot arm.

The carousel 130 may be arranged such that a robotic arm of a first workcell 111 may place a beverage container on a beverage container stand of the carousel 130, the carousel 130 may then operate to move the beverage container to within reach of a robotic arm of a second workcell 111, the robotic arm of the second workcell 111b may then remove the beverage container from a beverage container stand of the carousel 130. Alternatively, or additionally, the carousel 130 may be arranged such that a robotic arm of a first workcell 111a may place a beverage container on a beverage container stand of the carousel 130, the carousel 130 may then be arranged to store the beverage container for a period of time, the robotic arm of the first workcell 111a may then remove the beverage container from a beverage container stand of the carousel 130.

The beverage container stands may be provided with sensor(s) arranged to determine whether any given stand has a beverage container located upon it, and to provide a feedback signal to the control circuitry of the system Such sensors may be any suitable sensor known in the art, such as a weight sensor, a capacitive sensor, or an optical sensor.

### Presentation Station

Each workcell 111 may comprise a presentation station 114 for presenting a beverage to the consumer. The robotic arm 115 is configured to place a beverage container on the presentation station 114. As autonomous retail kiosks of the present disclosure are typically enclosed, the presentation station 114 can act as an air lock for both safety and hygiene reason. That is, in embodiments, a user can be prevented from accessing internals of the kiosk. In an embodiment, the presentation station 114 comprises a rotating platform with a bell jar affixed, wherein an opening large enough to accommodate the robotic arm and a beverage container is present on one side of the bell jar. The robotic arm 115 and presentation station 114 are arranged such that the robotic arm can place a beverage container on the rotating platform within the bell jar by moving through said opening. The robotic arm 115 is then arranged to retract out of the bell jar after placing the beverage container on the rotating platform. The presentation station 114 is then arranged to rotate, such that the opening of the bell jar faces the user and the beverage container is presented to a user. The presentation station 114 may be arranged to rotate 240 degrees. The presentation station 114 exhibits one degree of freedom, rotating about the axis normal to its surface.

### Beverage Maker

Each workcell 111 preferably comprises a beverage maker 150 connected to the beverage dispenser 113. Alternatively, one beverage maker 150 may serve multiple beverage dispensers of different workcells. Alternatively, multiple beverage makers 150 may serve a single beverage dispenser of a single workcell. The beverage maker 150 may be capable of making any type of beverage. The beverage maker 150 may be capable of producing soft drinks by mixing flavour syrups with still or sparkling water. The beverage maker 150 may be capable of producing hot drinks, such as coffee or tea. The beverage maker 150 may be capable of producing coffee from coffee beans or coffee grounds. Preferably, the beverage maker 150 is capable of producing coffee from coffee beans. Preferably, the beverage maker is also capable of producing hot and cold milk, including foamed milk for coffee drinks such as cappuccinos, lattes and flat whites.

### Beverage Container Dispenser

Each workcell 111 preferably comprises a beverage container dispenser. Alternatively, one beverage container dispenser may serve multiple workstations. The beverage container dispenser is arranged to dispense a beverage container to a gripper of a robotic arm. Preferably, the beverage container dispenser is arranged to dispense a single beverage container from a stack of beverage containers by rotating a screw having a thread that is arranged to move between and separate the beverage containers. Preferably, the beverage container dispenser comprises a carousel of beverage container dispensers which are rotatable to align the correct beverage container dispenser to the drop position. The beverage container dispenser may use any known means for separating the beverage containers.

### Beverage Container Lidder

Each workcell 111 may comprise a beverage container lidder 140. Preferably, a beverage container lidder 140 is located between two workcells 111a, 111b and arrange to apply a lid to a beverage container located in either of the two workcells 111a, 111b. Preferably, the beverage container lidder 140 comprises a robotic arm. Preferably, said robotic arm exhibits two degrees of freedom or two axis freedom. Preferably, said robotic arm is able to move up and down, and rotate about the z axis. Preferably, the beverage container lidder 140 further comprises a rotating carousel 141 arranged to hold a variety of lids. The rotating carousel 141 is arranged such that it is rotatable to position different lids under the robotic arm. In operation, the beverage container lidder 140 may be arranged such that the robotic arm removes a lid from the rotating carousel 141 and then applies said lid to a beverage container.

### Beverage Container Disposal Unit

The autonomous retail kiosk may comprise a beverage container disposal unit for disposing beverage containers into. Such a unit can be desirable so failed or uncollected beverages can be disposed of. A beverage container disposal unit may be arranged to receive a beverage container from a robotic arm. Each workcell 111 may comprise a beverage container disposal unit. Alternatively, a beverage container disposal unit may be shared by multiple workcells 111a . . . 111n. In another embodiment, beverage containers may be moved from the carousel or another position in the automated retail kiosk into a beverage container disposal unit by an actuator, such as an arm, which knocks the beverage container into the beverage container disposal unit.

### Ice Dispenser

The autonomous retail kiosk may comprise an ice dispenser for dispensing ice into beverage containers. Provision of an ice dispenser confers the ability to make iced drinks, such as iced lattes. Each workcell 111 may comprise an ice dispenser. Alternatively, an ice dispenser may be shared by multiple workcells 111a . . . 111a.

Preferably, the ice dispenser comprises a single ice machine with an ice delivery chute for delivering ice to each workcell. Preferably, the ice delivery chute comprises a directing element for directing ice to a particular workcell. The configuration avoids the need for the robotic arms to be able to reach a common location, whilst still only requiring one ice machine per automated retail kiosk.

The autonomous retail kiosk may comprise further resources that are either shared between workcells 111a . . . 111n or serve only one workcell 111. For example, the autonomous retail kiosk may further comprise apparatus arranged to dispense a food item, such as a muffin or a portion of ice cream, into a beverage container for serving to a user. The autonomous retail kiosk may also further comprise apparatus arranged to dispense aerosol or whipped cream into a beverage container for serving to a user. The autonomous retail kiosk may also further comprise apparatus arranged to dispense a portion of frozen yoghurt into a beverage container for serving to a user. The autonomous retail kiosk may also further comprise a blender for the preparation of blended drinks.

### Layout

The layout shown in FIG. 1 is thus comprised of an arrangement of low degree of freedom robots working in cooperation and accessible by a three degree of freedom robot arm. The presence of the carousel 130 and utilising at least two workcells means that a high degree of operational efficiency is possible, with improved failover capabilities, based on low-cost robotic equipment. The autonomous retail system described herein, comprising multiple workcells and linked by the carousel, may be configured such that the components within the respective workcells can work together to provide an improved autonomous retail system having improved functionality and/or simpler components over the prior art.

### Methods for Operating an Autonomous Retail Kiosk

The present disclosure also provides various methods of operating an autonomous retail kiosk comprising two or more production workcells and a carousel 130. The method may comprise the steps of, in a first production workcell: dispensing a beverage container from a beverage container dispenser to a first robotic arm, and moving the beverage container to a first load location on the carousel 130 using the first robotic arm. The carousel may then store the beverage container for a predetermined amount of time, which may depend on order information or machine state information. The beverage container may be stored by the carousel in a carousel position that is not within a work cell or robot arm work envelope. When required, the carousel may move the beverage container to a load position to be removed from the carousel 130 using one of the first robotic arm in a first production workcell, or a second robotic arm in a second production workcell.

In this way, beverage containers may be straightforwardly passed between workcells, or temporarily stored on the carousel if necessary. This can increase the duration of operation of an autonomous retail kiosk, prior to the requirement for replenishment of the consumables in the kiosk. Each workcell has access to certain consumables from each other workcell that is present in the autonomous retail kiosk.

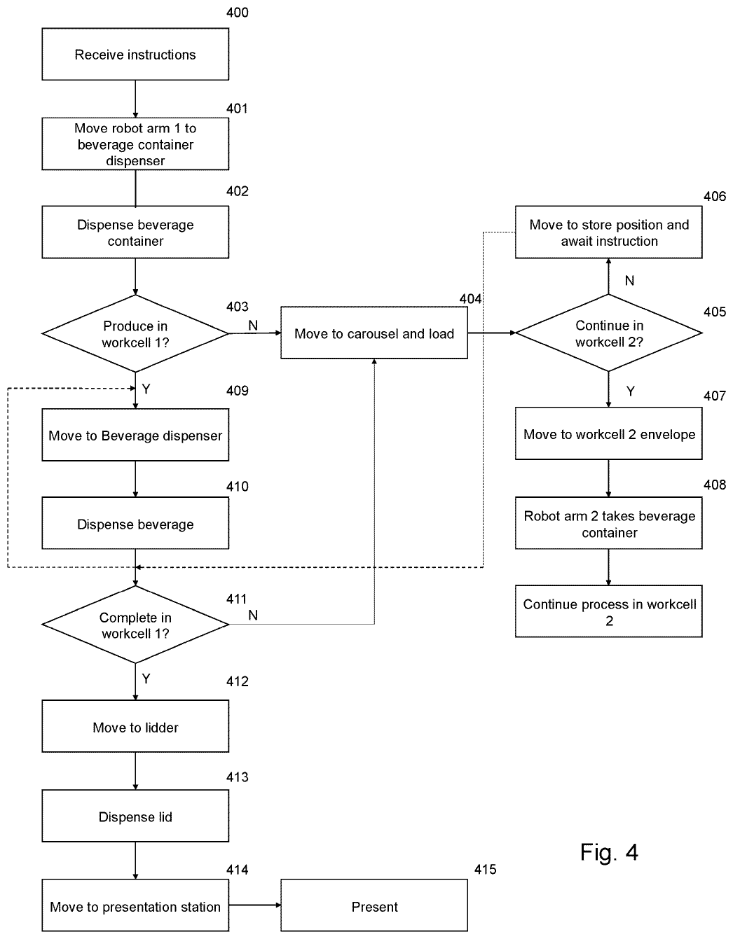

The flowchart shown in FIG. 4 describes a method for operating an automated kiosk according to the present disclosure. The method is described with first reference to a first workcell and a first robotic arm; it will be appreciated that the numbering of the workcell, robotic arm, etc., are for illustrative purposes, and could be varied within the scope of the disclosure. At 400 instructions are received at the autonomous retail kiosk. The instructions may be received via a wired or wireless connection from a local area network, wide area network, or the internet. The instructions may be received from a user interface that is provided at the automated retail kiosk itself. The instructions may comprise information about an order to be produced. The order may comprise one or more beverages including different sets of ingredients and requiring different machine resources to complete. The instructions may specify that the order is to be produced using only the resources of workcell 1, or a combination of workcell 1 and workcell 2. The instructions may further specify that the order is to be partially or wholly produced, and then stored at the carousel for a predetermined time period, or until a further user condition is satisfied. The user condition may be a user coming within a certain proximity of the automated retail kiosk, or providing further instructions that the order stored at the carousel be released and presented to the user.

At 401 the first robot arm is moved to the beverage container dispenser, and a beverage container is dispensed at 402, as described in the foregoing. At 403, if the instructions specify that the order is to be completed in a workcell other than workcell 1, the beverage container is moved by the robot arm to the carousel, and loaded onto a beverage container stand. If the instructions do not specify that the order should be continued immediately in workcell 2, the beverage container may be moved by the carousel to a store position (at 406) and may remain there until further instructions are received.

If at 405 the instructions specify that the order is to continue in another workcell, for example workcell 2, the carousel moves the beverage container to the workcell 2 working envelope at 407, so that the second robot arm can remove the beverage container from the carousel and continue with the order.

If at 403, the instructions specify that the order is to be produced in workcell 1, the method proceeds to 409. The instructions may specify that the order is to be wholly or partially produced in workcell 1. The instructions may specify that the order is to be wholly produced in workcell 1 in one or more stages, the stages occurring at different times—i.e., a first part of a beverage may be made, and then the beverage may be stored at the carousel for completion at a second, later time. At 409 the robot arm moves the beverage container to the beverage dispenser, which may dispense all or part of a beverage at 410. At 411 it is determined whether the order is for immediate completion at the first workcell. If the instructions specify that the order is not for immediate completion in the first workcell, the robot arm moves the beverage container (containing a fully or partially completed beverage) to the carousel and loads it on (at 404). The process may continue from there in either workcell 2 (steps 405,407 etc) or may be completed in workcell 1 (dashed progress lines in FIG. 4). The carousel may move the beverage container back to the work envelope of workcell 1 from a storage position in order that the first robot arm may take the beverage container and either continue to produce the beverage by proceeding to 409, or by completing the order by moving the beverage container to the lidder at 412. A lid is dispensed by the lidder in the manner described at 413. The robot arm then moves the beverage container to the presentation station, at 414. The finished product is presented to the user at 415.

Not shown in FIG. 4 are steps relating to other parts of a beverage, including moving the beverage container to an ice dispenser for ice dispensing, for example. Such steps may occur at any suitable point in the beverage production process, particularly at or between 409 and 410 of the beverage making process.

In another embodiment, a method of operation may comprise dispensing a beverage container from a beverage container dispenser to a first robotic arm, dispensing a liquid from the beverage dispenser 113 in the first production workcell into the beverage container, and placing the beverage container on the carousel. The method may further comprise removing the beverage container from the carousel 130 using the second robotic arm in the second production workcell, dispensing a liquid from the beverage dispenser 113 in the second production workcell into the beverage container, and presenting the beverage container to the consumer by placing the beverage on a presentation station 114 using the second robotic arm. This is useful where a drink may be partially completed in a first workcell, loaded onto the carousel 130, transferred to another (second) workcell for completion of the beverage prior to presenting the beverage to the user at the presentation station. This may be required where a first production workcell comprises a first portion of the ingredients required to produce a drink, and the second workcell comprises the remaining portion of the ingredients required. The autonomous retail kiosk may be configured to store a partially completed drink that is subject to an asynchronous order by a user—that is, an order received that is not for immediate presentation to the user. When placing an order, the user may specify a future time at which the beverage is to be presented. The carousel may therefore be used as storage to minimise the wait time for a user when they arrive at the kiosk to collect their product(s).

In another preferred embodiment, wherein removing the beverage container from the carousel 130 uses the second robotic arm in the second production workcell, the method further comprises; dispensing a liquid from the beverage dispenser 113 in the second production workcell into the beverage container, moving the beverage container to the carousel 130 using the first second robotic arm the method further comprising: removing the beverage container from the carousel 130 using one of the first robotic arm or a second robotic arm in a second production workcell, and presenting the beverage container to the consumer by placing the beverage on a presentation station 114 using the one of the first robotic arm or the second robotic arm.

In embodiments, the kiosk 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

### CLAUSES

1. An autonomous retail kiosk for serving beverages, comprising two or more production workcells and a carousel, wherein;
   each production workcell comprises;
   a beverage dispenser for dispensing liquid,
   a presentation station for presenting a beverage to the consumer,
   a robotic arm for moving beverages between the beverage dispenser, the presentation station and the carousel;
   and wherein
   said carousel is configured to receive a beverage container from a first robotic arm within a first workcell and deliver the beverage container to a second robotic arm within a second workcell, thereby moving the beverage container from the first workcell to the second workcell.
2. The autonomous retail kiosk of clause 1, wherein the planes in which each robotic arm is configured to move in consist of the lateral, vertical and transverse planes.
3. The autonomous retail kiosk of clause 1 or clause 2, further comprising one or more beverage makers configured to provide a beverage to the beverage dispenser.
4. The autonomous retail kiosk of any preceding clause, wherein the beverage dispenser is a moveable beverage dispensing head that is tiltable and elevatable.
5. The autonomous retail kiosk of any preceding clause, wherein the presentation station comprises a rotating platform.
6. The autonomous retail kiosk of any preceding clause, wherein the kiosk comprises two substantially identical production workcells with bilateral symmetry.
7. The autonomous retail kiosk of any preceding clause, wherein each robotic arm is configured to:
   move a beverage container from a beverage container dispenser to a beverage dispenser,
   move the beverage container from the beverage dispenser to the carousel, and
   move the beverage container from the carousel to a presentation station.
8. The autonomous retail kiosk of any preceding clause, further comprising a beverage container lidding station comprising a beverage container lidder which serves the two or more production workcells, or wherein each of the two or more production workcells further comprises one or more beverage container lidding stations each comprising a beverage container lidder.
9. The autonomous retail kiosk of clause any preceding clause, further comprising a beverage disposal receptacle for receiving a waste beverage from a robotic arm.
10. The autonomous retail kiosk of any preceding clause, wherein the carousel is further configured to receive a beverage container from a robotic arm and deliver the beverage container to the same robotic arm, thereby acting to store the beverage container.
11. A method of operating an autonomous retail kiosk comprising two or more production workcells and a carousel, comprising the steps of, in a first production workcell:
   dispensing a beverage container from a beverage container dispenser to a first robotic arm, and
   using the first robotic arm, moving the beverage container to the carousel,
   the method further comprising:
   removing the beverage container from the carousel using one of the first robotic arm or a second robotic arm in a second production workcell.
12. The method of operating an autonomous retail kiosk according to clause 11, wherein the method further comprises:
   moving the beverage container from the beverage container dispenser to a first beverage dispenser using the first robotic arm,
   dispensing a liquid from the beverage dispenser into the beverage container.
13. The method of operating an autonomous retail kiosk according to clause 11 or clause 12, wherein the method further comprises:
   presenting the beverage container to the consumer by placing the beverage container on a presentation station using the one of the first robotic arm or the second robotic arm.
14. The method of operating an autonomous retail kiosk according to clause 11 or clause 12, wherein removing the beverage container from the carousel uses the second robotic arm in the second production workcell, the method further comprising;
   dispensing a liquid from the beverage dispenser in the second production workcell into the beverage container, and
   presenting the beverage container to the consumer by placing the beverage on a presentation station using the second robotic arm.
15. The method of operating an autonomous retail kiosk according to clause 11 or clause 12, wherein removing the beverage container from the carousel uses the second robotic arm in the second production workcell, the method further comprising;
   dispensing a liquid from the beverage dispenser in the second production workcell into the beverage container,
   moving the beverage container to the carousel using the second robotic arm
   the method further comprising:
   removing the beverage container from the carousel using one of the first robotic arm or a second robotic arm in a second production workcell, and
   presenting the beverage container to the consumer by placing the beverage on a presentation station using the one of the first robotic arm or the second robotic arm.
16. A method of operating an autonomous retail kiosk comprising the steps of
   receiving at a controller information relating to ingredient or hardware resource availability of the two or more production workcells,
   determining based on said information if one or more of the two or more production workcells are capable of producing a beverage alone or in combination, and
   based on said determination performing the method of any one of clauses 11 to 15.

1. An autonomous retail kiosk for serving beverages, comprising two or more production workcells and a carousel, wherein;
each production workcell comprises;
a beverage dispenser for dispensing liquid,
a presentation station for presenting a beverage to a consumer,
a robotic arm for moving beverages between the beverage dispenser, the presentation station and the carousel;
and wherein
said carousel is configured to receive a beverage container from a first robotic arm within a first workcell and deliver the beverage container to a second robotic arm within a second workcell, thereby moving the beverage container from the first workcell to the second workcell.

2. The autonomous retail kiosk of claim 1, wherein the planes in which each robotic arm is configured to move in consist of the lateral, vertical and transverse planes.

3. The autonomous retail kiosk of claim 1, further comprising one or more beverage makers configured to provide a beverage to the beverage dispenser.

4. The autonomous retail kiosk of claim 1, wherein the beverage dispenser is a moveable beverage dispensing head that is tiltable and elevatable.

5. The autonomous retail kiosk of claim 1, wherein the presentation station comprises a rotating platform.

6. The autonomous retail kiosk of claim 1, wherein the kiosk comprises two substantially identical production workcells with bilateral symmetry.

7. The autonomous retail kiosk of claim 1, wherein each robotic arm is configured to:
move a beverage container from a beverage container dispenser to a beverage dispenser,
move the beverage container from the beverage dispenser to the carousel, and
move the beverage container from the carousel to a presentation station.

8. The autonomous retail kiosk of claim 1, further comprising a beverage container lidding station comprising a beverage container lidder which serves the two or more production workcells, or wherein each of the two or more production workcells further comprises one or more beverage container lidding stations each comprising a beverage container lidder.

9. The autonomous retail kiosk of claim 1, further comprising a beverage disposal receptacle for receiving a waste beverage from a robotic arm.

10. The autonomous retail kiosk of claim 1, wherein the carousel is further configured to receive a beverage container from a robotic arm and deliver the beverage container to the same robotic arm, thereby acting to store the beverage container.

11. A method of operating an autonomous retail kiosk comprising two or more production workcells and a carousel, comprising the steps of, in a first production workcell:
dispensing a beverage container from a beverage container dispenser to a first robotic arm, and
using the first robotic arm, moving the beverage container to the carousel,
the method further comprising:
removing the beverage container from the carousel using one of the first robotic arm or a second robotic arm in a second production workcell.

12. The method of operating an autonomous retail kiosk according to claim 11, wherein the method further comprises:
moving the beverage container from the beverage container dispenser to a first beverage dispenser using the first robotic arm,
dispensing a liquid from the beverage dispenser into the beverage container.

13. The method of operating an autonomous retail kiosk according to claim 11, wherein the method further comprises:
presenting the beverage container to a consumer by placing the beverage container on a presentation station using the one of the first robotic arm or the second robotic arm.

14. The method of operating an autonomous retail kiosk according to claim 11, wherein removing the beverage container from the carousel uses the second robotic arm in the second production workcell, the method further comprising;
dispensing a liquid from the beverage dispenser in the second production workcell into the beverage container, and
presenting the beverage container to a consumer by placing the beverage on a presentation station using the second robotic arm.

15. The method of operating an autonomous retail kiosk according to claim 11, wherein removing the beverage container from the carousel uses the second robotic arm in the second production workcell, the method further comprising;
dispensing a liquid from the beverage dispenser in the second production workcell into the beverage container,
moving the beverage container to the carousel using the second robotic arm
the method further comprising:
removing the beverage container from the carousel using one of the first robotic arm or a second robotic arm in a second production workcell, and
presenting the beverage container to a consumer by placing the beverage on a presentation station using the one of the first robotic arm or the second robotic arm.

16. A method of operating an autonomous retail kiosk comprising the steps of
receiving at a controller information relating to ingredient or hardware resource availability of the two or more production workcells,
determining based on said information if one or more of the two or more production workcells are capable of producing a beverage alone or in combination, and
based on said determination performing the method of claim 11.
